(19) United States
(12) Patent Application Publication
(10) Pub. No.: US 2006/0166049 A1
(43) Pub. Date: Jul. 27, 2006

(54) Method and an arrangement for producing electric energy by means of at least one fuel cell

(76) Inventor: Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/517,822

(22) PCT Filed: Apr. 19, 2003
(86) PCT No.: PCT/EP03/04104

§ 371 Date: Jul. 19, 2005

(30) Foreign Application Priority Data
Jun. 15, 2002 (DE) 102 26 689.1

(51) Int. Cl. H01M 8/00; H01M 2/02

(52) U.S. Cl. 429/13; 429/34; 429/12

(57) ABSTRACT

The invention relates to a method and an arrangement for generating electrical energy with at least one fuel cell. The fuel cell has a membrane unit for direct or indirect separation and/or for transporting charge carriers and/or reaction products. The membrane unit has an angle of inclination of 45° or a smaller angle of inclination with respect to the horizontal.

### BACKGROUND AND SUMMARY OF THE INVENTION

This invention relates to a method and an arrangement for generating electrical energy using at least one fuel cell which has a membrane unit for direct or indirect separation and/or for transporting charge carriers and/or reaction gases, it being possible for gaseous fuel to be fed to an anode on one side of a polymer membrane belonging to the membrane unit and for an oxidizing gas to be supplied to a cathode on the other side of the polymer membrane, and for gaseous reaction products to be discharged.

A drive unit in a vehicle which has an electric driving motor, a fuel cell and a fuel tank, a water store, an evaporator and a reformer is known. The fuel tank contains methanol which, with water from the water store, is converted into the gaseous state in the evaporator and is then passed to the reformer, in which substantially hydrogen, carbon dioxide and carbon monoxide are formed when heat is supplied by means of a catalytic burner. The carbon monoxide can be oxidized using an oxidizing agent. The hydrogen-containing fuel gas from the reformer is fed by means of a compressor to the fuel cell, which comprises a fuel cell stack in which a large number of individual fuel cell modules are integrated. Humidified air is fed to the fuel cell by a further compressor. In the fuel cell, electrical energy for the electric driving motor is generated from the hydrogen and the oxygen of the air (See German publication DE 44 12 450 A1).

A fuel cell with convection-driven mass transfer (See German publication DE 196 42 754 (2)) is also known. The fuel cell comprises a stack of fuel cell modules. The stack is elongate in form, with a width to height ratio of approx. 1:5 and is arranged in a circuit for the recirculation of fuel. The circuit has a lower turning point and an upper turning point. The fuel flows in the circuit outside the fuel cell to the lower turning point and, from there, into the fuel cell, in which it is heated and therefore rises upward. Fuel which is not consumed rises up to the upper turning point and then passes into a circuit section provided with cooling fins, where it is cooled and therefore flows back to the lower turning point under the influence of the force of gravity. On account of its mode of operation, without the use of pumps and compressors, this fuel cell increases the efficiency.

The invention addresses the problem of providing a method and arrangement for generating electrical energy using a fuel cell, with which, when the fuel cell is operating, more uniform conditions for the separation of the reaction gases, the charge carrier transfer and the discharge of the reaction products can be achieved in its membrane unit.

In a method of the type described in the introduction, the problem is solved, according to the invention, by virtue of the fact that the membrane unit, while the fuel cell is operating, is held in a position which has an angle of inclination of 45° or a smaller angle of inclination with respect to the horizontal. In this context, the term horizontal is to be understood as meaning a plane which runs at right angles to the direction of gravity. The method according to the invention at least to a significant extent avoids a gas pressure which differs as a function of height on account of the force of gravity and therefore also avoids a differing water vapor content in the reaction gases and in the polymer membrane. This results in a relatively uniform moisture content or electrolyte content in the entire membrane region. The influence of the force of gravity on the electrolyte likewise becomes more uniform. Therefore, the membrane region makes a more uniform contribution to the generation of energy. Uneven loads in the membrane zone and therefore a reduction in the membrane service life can therefore likewise be avoided. In this context, the term membrane unit is to be understood as meaning that component of a fuel cell which is used directly or indirectly for separating and/or transporting charge carriers and/or reaction gases. In this context, the term polymer membrane is to be understood as meaning the polymer membrane of a fuel cell module and also the combination of polymer membranes of the fuel cell modules which, for example, are connected in series in a stack.

In particular, the membrane unit is arranged in a plane which runs at right angles to the direction of the force of gravity. An orientation of this type achieves particularly good conditions in the polymer membrane with regard to the distribution of moisture or electrolyte.

In an arrangement of the type described in the introduction, the problem is solved, according to the invention, by the fact that a membrane unit of the fuel cell is connected to a carrier in such a manner that it has an angle of inclination of 45° or a smaller angle of inclination with respect to the horizontal.

In a preferred embodiment, the membrane unit of the fuel cell is arranged in a road vehicle for transporting passengers and/or goods, along at least one plane which, in the horizontal position of the vehicle, is oriented at a right angle or virtually a right angle to the direction of the force of gravity.

Road vehicles are not usually allowed to drive on roads with inclinations of up to 45°, i.e. the fuel cell, in operation, generally has an angle of inclination of significantly smaller than 45° with respect to the horizontal. Accordingly, there is virtually always a uniform distribution of moisture and electrolyte in the membrane unit.

The invention is described in more detail below on the basis of an exemplary embodiment illustrated in the drawings, which will reveal further features, details and advantages.

### BRIEF DESCRIPTION OF THE DRAWINGS

FIG. 1 shows a diagrammatic, partially perspective and sectional view of a membrane unit of a fuel cell, and

FIG. 2 diagrammatically depicts a vehicle with an electric drive and a fuel cell for generating the driving energy.

### DETAILED DESCRIPTION OF THE INVENTION

The drawing provides a diagrammatic, partially perspective and sectional illustration of a membrane unit 1 of a fuel cell module. An electrolyte membrane 2 is on one side connected to a cathode 3 which is gas-permeable. On the other side, the membrane 2 is connected to a gas-permeable anode 4. The cathode 3 and the anode 4 may in each case consist of a carbon fabric. A gas-impermeable plate 5 adjoins the cathode 3 and, on its side facing the cathode 3, has a series of fins 6 at regular intervals. The cavities 7 between the fins 6, together with the cathode 3, form passages in which oxidizing gas, e.g. air with an oxygen content, is fed to the cathode 3.

A gas-impermeable plate 8 adjoins the anode 4 and has fins 9 which are arranged at regular intervals. The fins 9 touch the anode 4 and with the latter form passages 10 in which gaseous fuel, e.g. a hydrogen-containing gas, is fed to the anode 4. The plates 5, 8 of adjacent fuel cell modules may in each case have fins on both sides, so as to be designed to supply fuel gases and oxidizing gases to the adjacent cells.

The electrolyte membrane 2 is a proton-conducting ion exchange membrane made from a polymer material, e.g. fluorinated resin, with a very good electrical conductivity in the moist state. The surface of the membrane 2 is covered with a catalyst. The electrolyte membrane 2 is moistened by the reaction water and the humidity of the reaction gases during operation of the fuel cell.

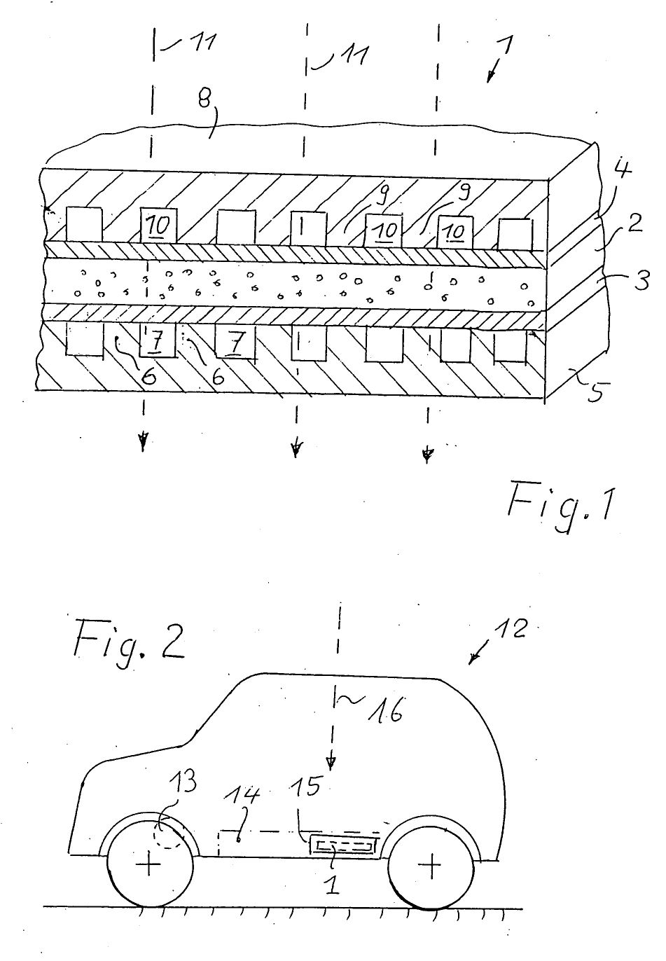

When the fuel cell is operating, the membrane unit 1 is held in a position which runs at right angles to the direction of the force of gravity or at least is inclined at an angle of less than 45° with respect to the direction of the force of gravity. The direction of the force of gravity is symbolically illustrated by the dashed arrows 11 in FIG. 1. The term when the fuel cell is operating is to be understood as meaning that the fuel cell is being excited to generate an electric voltage and if appropriate release an electric current between cathode 3 and anode 4.

The orientation of the membrane unit 1 according to the invention in the manner described above with respect to the direction of the force of gravity substantially avoids uneven humidification of the polymer membrane 2. This applies in general terms to the moisture of electrolytes used for charge transport. The more uniform wetting of the polymer membrane 2 with water or another electrolyte also makes the loading on the membrane region as a whole more uniform. If the polymer membrane 2 does not have regions which are subject to different levels of loading, it is better protected against damage, which increases the service life of the membrane.

The horizontal arrangement of the membrane unit 1 with respect to the force of gravity as described above (the term horizontal should also be understood as encompassing an inclination of less than 45°) also has the advantage of promoting the removal of the water vapor formed during the reaction and therefore the dehumidification of the polymer membrane 2.

FIG. 2 diagrammatically depicts a side view of an electric vehicle 12 for transporting passengers. An electric motor 13 is provided at the front axle for driving the electric vehicle 12. To supply the vehicle 12, in particular the electric motor 13, with energy, there is a fuel cell system 14 which, in a manner which is known per se, has a fuel tank, a water store, an evaporator, a reformer and a fuel cell 15 which includes fuel cell modules with membrane units 1.

In the electric vehicle 12, the fuel cell modules 15 are arranged on a carrier in such a way that the membrane units 1 extend along planes which, when the electric vehicle 12 is in a horizontal position, form a right angle with the direction of the force of gravity, which is represented by a symbolic arrow 16 in FIG. 2.

Vehicles for transporting passengers and/or goods are usually permitted to operate on a limited inclination of road of, for example, less than 20°. Arranging the membrane units 1 parallel to the floor part of the vehicle or to a horizontal road, as illustrated in FIG. 2, has the advantage that there is virtually no height-dependent distribution of moisture. Both the wetting of the polymer membranes 2 and the dehumidification as a result of the reaction gases forming when the fuel cell is operating are therefore virtually uniform over the polymer membrane region.

1-4. (canceled)

5. An arrangement for generating electrical energy having at least one fuel cell which has a membrane unit for direct or indirect separation, for transporting at least one of charge carriers and reaction gases, or for both direct or indirect separation and transporting at least one of charge carriers and reaction gases, it being possible for gaseous fuel to be fed to an anode on one side of a polymer membrane belonging to the membrane unit and for an oxidizing gas to be supplied to a cathode on the other side of the polymer membrane, and for reaction products to be discharged, wherein the membrane unit is arranged in a fuel cell in a road vehicle for transporting at least one of goods and passengers, along a plane which, in a horizontal position of the vehicle, runs at a right angle or virtually at a right angle to the direction of the force of gravity.

6. A membrane unit for at least one of direct or indirect separation, transporting charge carriers, and transporting reaction gases adopted for use in a fuel cell of an arrangement for generating electrical energy and for discharging reaction products, comprising:
a polymer membrane,
an anode on one side of the polymer membrane to which gaseous fuel can be fed, and
a cathode on the other side of the polymer membrane to which an oxidizing gas can be supplied,
wherein the membrane unit is arranged along a plane which, in a horizontal position of a vehicle, runs at or virtually at a right angle to a direction of the force of gravity.

7. The membrane unit as claimed in claim 6, wherein the vehicle is a road vehicle for transporting goods.

8. The membrane unit as claimed in claim 6, wherein the vehicle is a road vehicle for transporting passengers.

9. The membrane unit as claimed in claim 6, wherein the vehicle is a road vehicle for transporting goods and passengers.
